(19) United States
(12) Patent Application Publication
(10) Pub. No.: US 2009/0321510 A1
(43) Pub. Date: Dec. 31, 2009

(54) Token communication

(75) Inventors: Philip N. Day, St. Andrews (GB); Simon J. Forrest, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/156,172

(22) Filed: May 30, 2008

(51) Int. Cl. G06F 17/00; G06K 7/00

(52) U.S. Cl. 235/375; 235/439

(57) ABSTRACT

A method of improving communications between a wireless proximity token (such as a radio-frequency card) and a proximity token reader. The method comprises: (a) detecting a position of the proximity token relative to the proximity token reader; (b) providing feedback to a user about the detected position of the proximity token relative to a desired position for satisfactory communication between the proximity token and the proximity token reader; and (c) repeating steps (a) and (b) until communication between the proximity token and the proximity token reader has been completed or a preset time interval has elapsed.

### FIELD OF INVENTION

The present invention relates to token communication.

### BACKGROUND OF INVENTION

Tokens, such as integrated circuit cards, RFID cards, and the like, are commonly used for various purposes, such as: initiating transactions, effecting payment, gaining access to secure areas, storing personal information, and the like. Such tokens are sometimes used to claim an identity that is confirmed by entry of a passcode (such as a personal identification number) associated with the claimed identity, or by application of a biometric (such as a fingerprint, iris pattern, or the like).

To improve user interaction, non-contact (also referred to as proximity) tokens are sometimes used. These proximity tokens are able to communicate with a token reader provided the token is maintained in close proximity to (which includes contact with) the token reader.

One problem, particularly with transactions that are not instantaneous (that is, transactions that extend over a period of time (such as sixty seconds)), is that some users do not maintain the proximity token in close proximity to the token reader for the entire transaction, so the token reader may not be able to write to (or read from) the token during a transaction. This can cause the transaction to fail.

### SUMMARY OF INVENTION

Accordingly, the invention generally provides methods, systems, apparatus, and software for improving communications between a token reader and a proximity token.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a method of improving communications between a proximity token and a proximity token reader, the method comprising:

(a) detecting a position of the proximity token relative to the proximity token reader;

(b) providing feedback to a user about the detected position of the proximity token relative to a desired position for satisfactory communication between the proximity token and the proximity token reader;

(c) repeating steps (a) and (b) until communication between the proximity token and the proximity token reader has been completed or a preset time interval has elapsed.

The method may comprise the further step (a-1) of detecting an amount of background noise and compensating for this detected background noise during step (a).

Step (a) may include detecting a distance of the proximity token from the proximity token reader in a first direction. Alternatively, or additionally, step (a) may include detecting displacement of the proximity token from the token reader in a second direction orthogonal to the first direction. Alternatively, or additionally, step (a) may include detecting displacement of the proximity token from the token reader in a third direction orthogonal to the first and second directions. Any other convenient method may be used to detect the position of the proximity token, for example, using a rotation measure to indicate the rotation of the proximity token.

Step (a) may include calculating the position of the proximity token based on the signal strength, the power of the token reader, the gain of the antenna on the token reader, and the gain of the antenna on the proximity token.

Step (b) may comprise providing visual feedback to the user via a display. Alternatively, or additionally, step (b) may comprise providing visual feedback to the user via visual elements on the proximity token reader. The visual elements may be one or more LEDs, one or more LCDs, or the like. Alternatively, or additionally, step (b) may comprise providing audible feedback to the user via a loudspeaker or a private audio device, such as earphones.

The visual feedback may be in the form of the detected position superimposed on the desired position so that the user can easily ascertain how the proximity token should be moved to ensure that the proximity token is maintained in the desired position. Alternatively, or additionally, the visual feedback may provide an arrow pointing in a direction that the proximity token should be moved in to achieve the desired position.

Step (b) may comprise an indication of whether the detected position is satisfactory, borderline, or unsatisfactory for reliable communication between the proximity token and the proximity reader.

The method may comprise the further step (c-1) of indicating to the user when the token reader is communicating with the proximity token. This indication may be visual and/or audible.

The method may comprise the further step (d) aborting communication with the proximity token and indicating that a communication failure has occurred when the preset time interval has elapsed.

As used herein, a proximity token refers to any device that can be used to communicate with a token reader in a wireless, point-to-point manner at relatively short range (less than two meters, typically less than 15 cm) from the token reader. Point-to-point refers to direct communication from the proximity token to the token reader without any requirement for an intermediate transceiver to receive, optionally boost, and forward the wireless signal. Thus, wireless telephony (such as is used by a conventional cellular radiofrequency telephone) is not point-to-point because additional transceivers (cellphone towers) are provided to form a cellular network.

According to a second aspect there is provided a proximity token reader comprising a processor; an antenna coupled to the processor for communicating with a proximity token; and a visual indicator; the processor being operable to detect a position of a proximity token relative to the antenna; and to provide feedback to a user via the visual indicator about the detected position of the proximity token relative to a desired position for satisfactory communication between the proximity token and the antenna.

The visual indicator may comprise one or more LEDs (such as an array of LEDs), one or more LCDs, or the like.

According to a third aspect there is provided a self-service terminal comprising: a proximity token reader including a processor associated with the proximity token reader; a terminal processor associated with the self-service terminal, and in communication with the proximity token reader; and a display controlled by the terminal processor; the reader processor being operable (i) to detect a position of a proximity token relative to the proximity token reader; and (ii) to provide feedback to a user about the detected position of the proximity token relative to a desired position for satisfactory communication between the proximity token and the proximity token reader.

The self-service terminal may further comprise a visual indicator associated with the proximity token reader and controlled by the reader processor.

The self-service terminal may be an automated teller machine (ATM), an information kiosk, a financial services centre, a bill payment kiosk, a lottery kiosk, a postal services machine, a check-in and/or check-out terminal such as those used in the hotel, car rental, healthcare, gaming, and airline industries, a retail self-checkout terminal, a vending machine, or the like.

According to a fourth aspect of the invention there is provided a computer readable medium tangibly embodying one or more programs of instructions executable by a computer, to perform all of the method steps of the first aspect of the invention.

These and other aspects will be apparent from the following specific description, given by way of example, with reference to the accompanying drawings.

### BRIEF DESCRIPTION OF THE DRAWINGS

FIG. 1 is a block diagram of a self-service terminal including a proximity token reader for communicating with a proximity token in accordance with one embodiment of the present invention;

FIG. 2 is a schematic diagram showing a component (the proximity token reader) of the terminal of FIG. 1 in more detail;

FIG. 3 is a pictorial view of part of the terminal of FIG. 1 showing alignment of part of the proximity token reader of FIG. 2 with another part (the fascia) of the terminal of FIG. 1;

FIG. 4 is a flow diagram illustrating the operation of the terminal of FIG. 1;

FIGS. 5a to 5c illustrate a proximity token (in the form of an RF card) located in three different positions relative to the proximity token reader of FIG. 2;

FIGS. 6a to 6c illustrate a first optional implementation of visual feedback via a display of the terminal of FIG. 1; and

FIGS. 7a to 7c illustrate a second optional implementation of visual feedback via the display of the terminal of FIG. 1.

### DETAILED DESCRIPTION

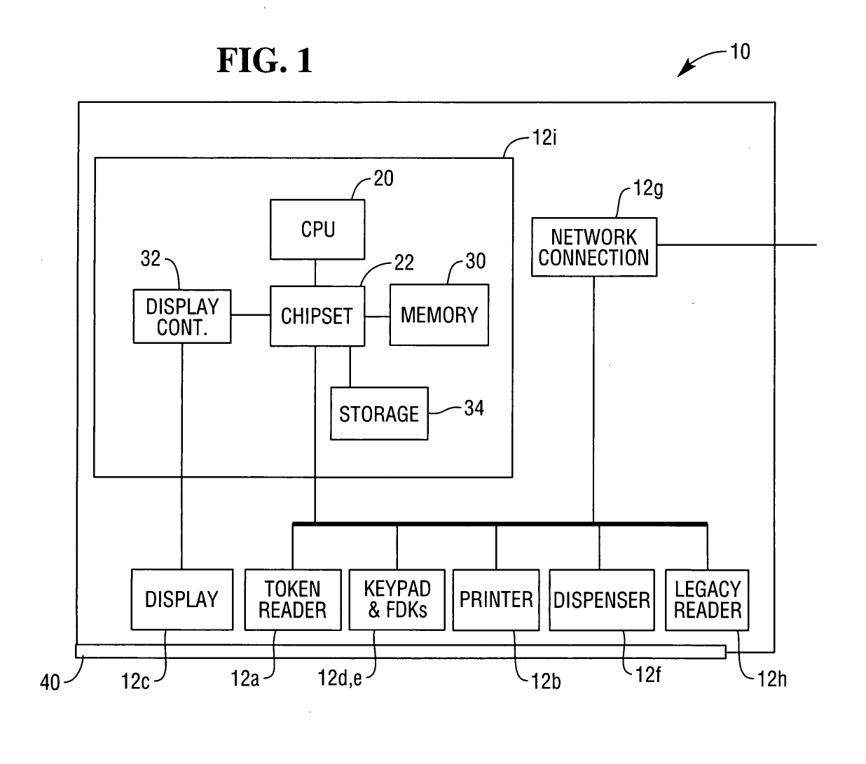

Reference is first made to FIG. 1, which is a block diagram illustrating the architecture of a self-service terminal 10, in the form of an ATM, according to one embodiment of the present invention.

The ATM 10 comprises a plurality of internal devices 12 mounted within the ATM 10, including: a proximity token reader device 12a (hereinafter a proximity reader); a receipt printer device 12b; a display 12c and associated function display keys (FDKs) 12d disposed as two columns, each on opposing sides of the display 12c; an encrypting keypad device 12e; a dispenser device 12f; a network device 12g for accessing a remote host (not shown); a legacy reader 12h for reading magnetic stripe and/or contact integrated circuit cards; and a controller device 12i (in the form of a PC core) for controlling the operation of the ATM 10, including the operation of the other devices 12a to 12h.

The ATM controller 12i comprises one or more microprocessors (CPU) 20 coupled to a chipset 22. In this embodiment, the chipset 22 is an 815 series chipset available from Intel Corporation (trade mark). The chipset 22 is coupled to main memory 30, and to a display controller 32, in the form of a graphics card, which drives the display 12c. Permanent storage, in the form of a disk drive 34, is also coupled to the chipset 22.

A fascia 40 is provided on the front of the ATM 10 as a customer interface to define slots through which some of the internal devices 12 protrude to allow customer interaction with those devices 12.

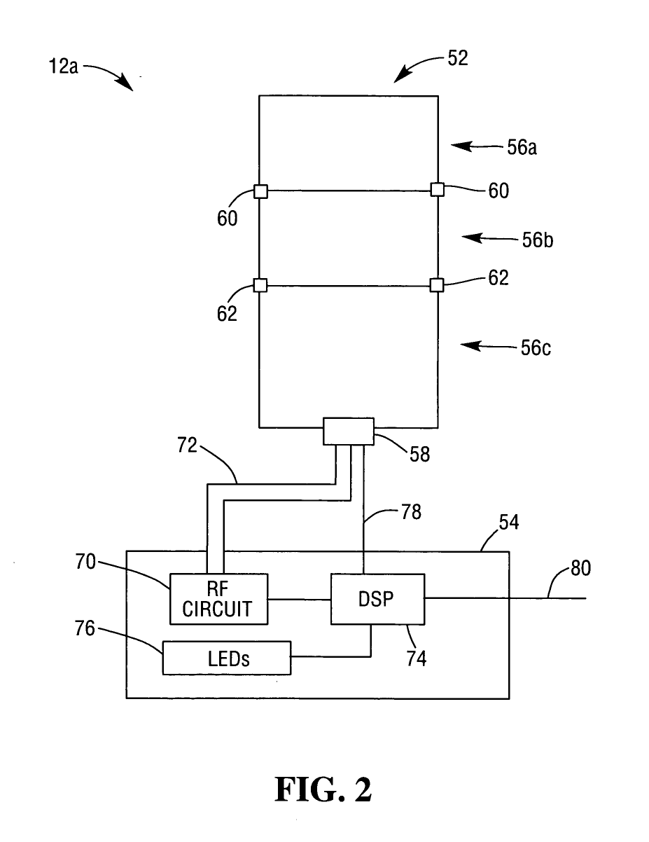

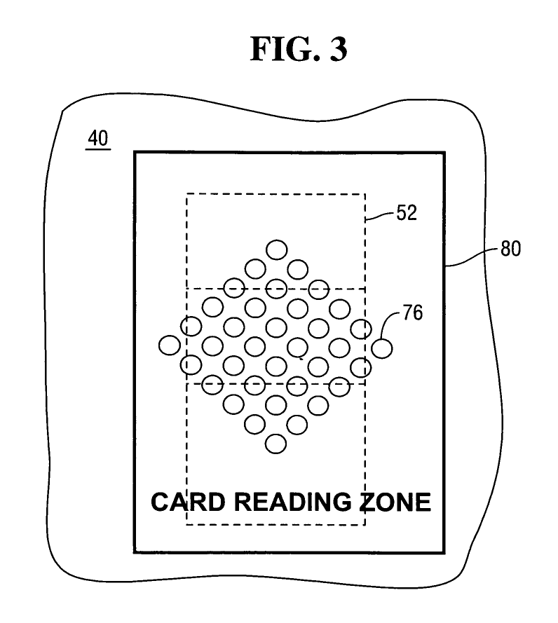

Reference will now be made to FIG. 2, which shows the proximity reader 12a in more detail. The proximity reader 12a comprises a radio-frequency antenna system 52 coupled to a reader controller 54.

The antenna system 52 comprises a plurality of antenna segments 56 (three antenna segments 56a,b,c are shown in this embodiment), each of which is coupled to an antenna management system 58.

The first antenna segment 56a is separated from the second antenna segment 56b by antenna junctions 60; and the second antenna segment 56b is separated from the third antenna segment 56c by antenna junctions 62.

The reader controller 54 comprises an RF circuit 70 for communicating with the antenna management system 58 via a coaxial cable 72; a microprocessor 74 (in the form of a digital signal processor (DSP)) coupled to the RF circuit 70, and an array of light emitting diodes (LEDs) 76. The DSP 74 is coupled directly to the antenna management system 58 by a control channel 78, and is also coupled to the ATM controller 12i by a data bus 80. The DSP 74 uses the data bus 80 to send information to, and receive commands from, the ATM controller 12i.

The antenna management system 58 controls RF communication between the antenna system 52 and a proximity token (not shown in FIG. 2). The operations performed by the antenna management system 58 include the following: (i) distributing an RF signal received from the RF circuit 70 to the antenna segments 56; (ii) combining signals received from the antenna segments 56 and transmitting these signals to the RF circuit 70; (iii) monitoring the signal strength received from each of the antenna segments 56; and (iv) providing the DSP 74 with the monitored signal strength information via the control channel 78.

The control channel 78 is used to provide information about the relative signal strength received from each antenna segment 56. This information allows the DSP to ascertain the location of a proximity token (in this embodiment an RF ATM card (hereinafter “RF card”)) relative to the antenna system 52. This is possible because the DSP 74 knows the gain of the antenna segments 56, the gain of a conventional proximity token (compliant with ISO 14443A/B, ISO 15693, MiFare, NFC, ISO 18000-3), and the power the DSP 74 supplies (via the RF circuit 70) to the antenna management system 58. The DSP 74 uses this information to calculate the position of a proximity token (not shown) relative to the antenna segments 56.

When installed in the ATM 10, the radio-frequency antenna system 52 is mounted on a rear surface of the fascia 40, and each LED in the array of LEDs 76 protrudes through corresponding apertures in the fascia 40 so that the LEDs 76 are visible to an ATM customer. The LEDs 76 are tri-color LEDs that can be illuminated as green, red, or yellow.

A reading zone 80 on the fascia 40 is marked by a decal to enable ATM customers to identify where they should present their RF cards (or other tokens). The reading zone 80 is in registration with the radio-frequency antenna system 52 to ensure that if the token is held close to, and in registration with, the reading zone 80 then the RF card will be read by the proximity reader 12a.

The reader controller 54 may be mounted adjacent to the radio-frequency antenna system 52 or located within the ATM housing rather than on the fascia 40.

ATM Transaction Operation

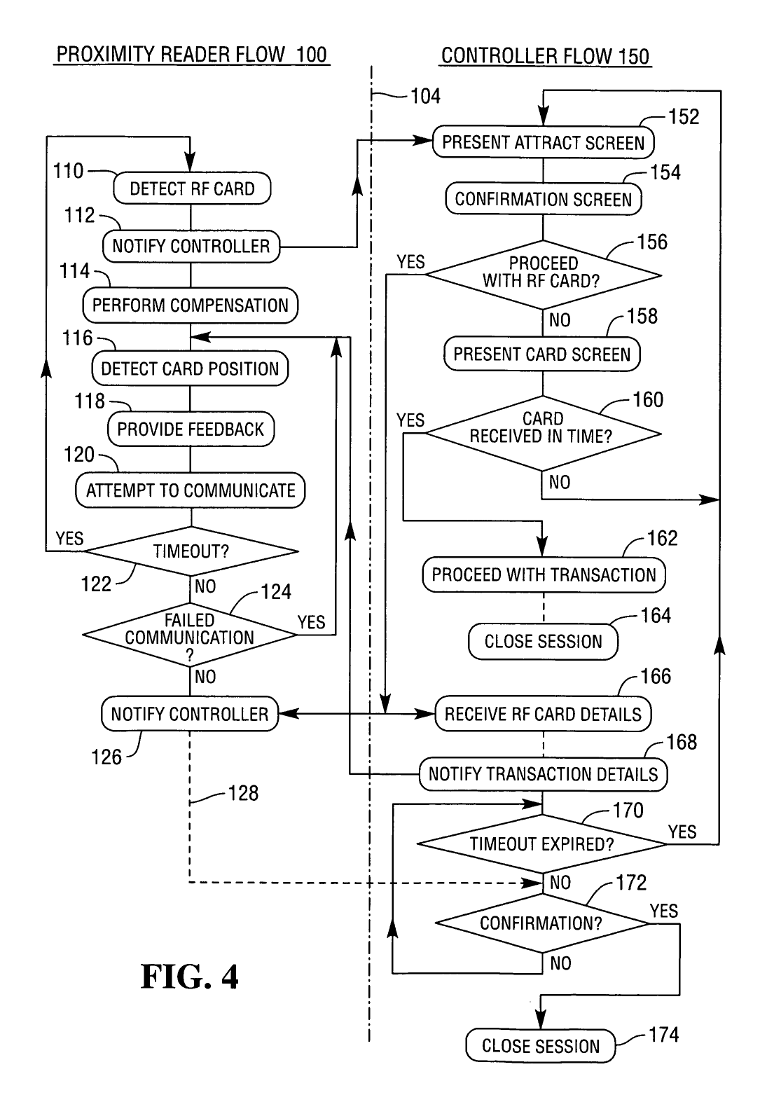

The operation of the proximity reader 12a and the controller 12i during a transaction will now be described with reference to FIG. 4, which is a flow diagram illustrating the operation of the ATM 10 during a transaction involving the proximity reader 12a. The left side of FIG. 4 illustrates steps performed by the proximity reader 12a (the proximity reader flow 100), and the right side of FIG. 4 illustrates steps performed by the ATM controller 12i (the ATM controller flow 150).

Arrows crossing the boundary 104 between the proximity reader flow 100 and the controller flow 150 illustrate messages sent from one device to the other relating to the transaction. FIG. 4 is a simplified diagram and does not show all of the communications that take place. Furthermore, the proximity reader flow 100 and the ATM controller flow 150 proceed in parallel. Some actions from one flow (100 or 150) influence, trigger, or change the operations performed in the other flow (150 or 100).

Initially, the ATM 10 presents an attract screen on the display 12c (step 152). The attract screen invites a potential ATM customer to present an RF card (or other proximity token) to the reading zone 80. The attract screen is presented until either an RF card is presented to the reading zone 80 or a conventional ATM card is inserted into the legacy reader 12h.

Only Conventional ATM Card Inserted

If a conventional ATM card is inserted into the legacy reader 12h without any RF card being presented to the proximity reader 12a then a transaction will proceed using the conventional ATM card in a manner consistent with a typical ATM transaction today. This is well known and is not illustrated in FIG. 4.

Only RF Card Presented

When an ATM customer presents his/her RF card to the reading zone 80, the antenna system 52 detects the RF card (step 110) and notifies the reader controller 54 (via coaxial cable 72), which in turn notifies the ATM controller 12i (step 112).

In parallel with notifying the ATM controller 12i, the reader controller 54 performs a reference compensation operation (step 114) by entering a compensation mode.

Compensation mode is invoked to compensate for the effects of stray or background RF noise. Compensation mode involves sampling RF noise at the reading zone 80 without transmitting any signal from the antenna system 52 (that is, the antenna system 52 only receives RF signals from the vicinity of the reading zone 80). Since the RF cards used in this embodiment do not transmit RF signals (they merely modulate and reflect incident RF signals), when operating in compensation mode the antenna system 52 measures the background RF noise, for example, from cellular telephones, electrical devices, passing vehicles, and the like. This measured background noise is then subtracted from RF signals measured throughout the transaction with the detected RF card. This compensates for background RF noise.

Once the background measurement has been recorded, the proximity reader 12a enters a communication phase (steps 116 to 124). These same steps are implemented for reading from the RF card and writing to the RF card.

The communication phase is implemented in parallel with the ATM controller 12i presenting screens to the ATM customer (described in more detail below).

The first step in the communication phase is for the proximity reader 12a to detect the position of the RF card relative to the antenna system 52 (step 116). As described above, this is performed by the DSP 74 measuring the RF signal strength received at each antenna segment 56 (once the background RF noise has been subtracted). The measured signal strength is influenced by a number of factors, including the distance between the RF card and the antenna system 52, the angle of incidence of the RF card and the field of the antenna system 52, and any movement of the RF card in this field.

If the RF card is too close to the antenna system 52, then the RF card can enter a ‘dead zone’, although this can be mitigated by appropriate mounting of the antenna system 52 behind the fascia 40 so that even when the RF card is placed on the reading zone 80, the RF card is still within the active field of the antenna system 52. The angle of incidence can seriously affect the ability of the antenna system 52 to read the RF card, (in extreme cases when the RF card is perpendicular to the field it cannot be read at all).

The DSP 74 uses the gain of the antenna segments 56, the gain of the RF card, and the power the DSP 74 supplies (via the RF circuit 70) to the antenna management system 58 to calculate the position of the RF card relative to the antenna segments 56.

Once the DSP 74 has detected the position of the RF card relative to the antenna system 52, the proximity reader 12a provides feedback to the ATM customer about the position of the RF card (step 118).

Visual Feedback to ATM Customer

To optimize communication with the RF card, the proximity reader 12a provides feedback (step 118) to the ATM customer prior to and during communications with the customer's RF card. Feedback is provided by detecting a position of the RF card relative to the antenna system 52 and providing a visual indication to the ATM customer about the detected position of the RF card relative to a desired position for satisfactory communication between the RF card and the antenna system 52.

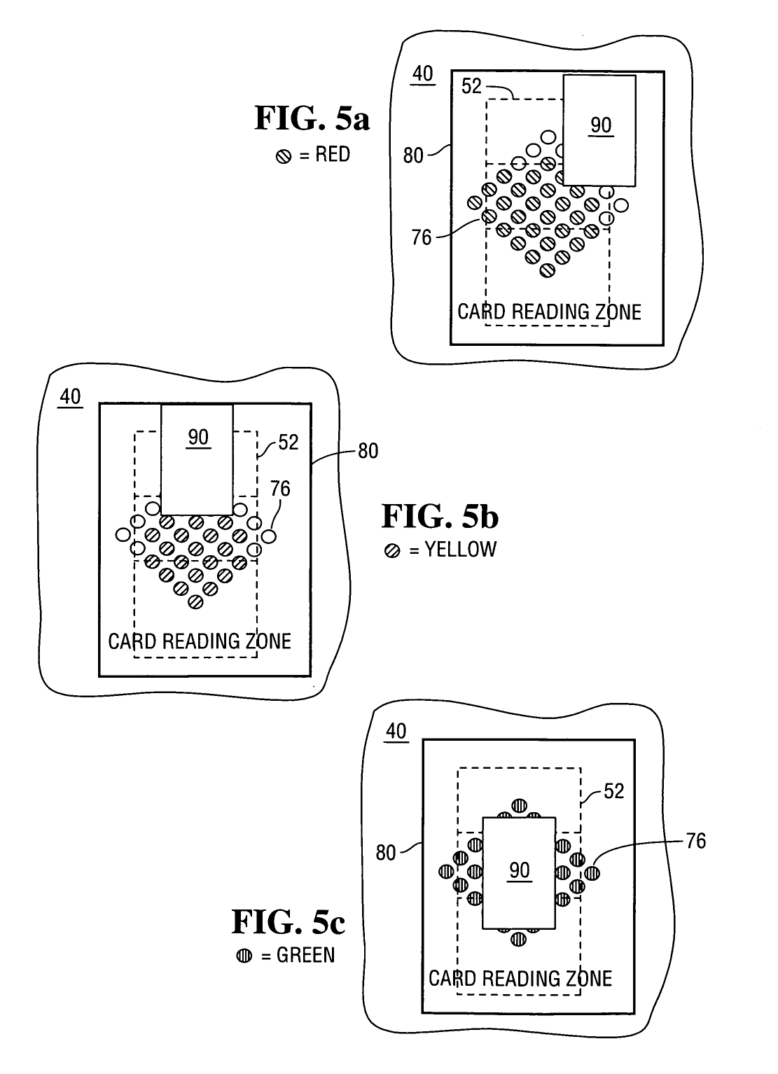

Providing feedback about the RF card's position is explained in more detail with reference to FIGS. 5a to 5c, which illustrate an RF card 90 located in three different positions relative to the reading zone 80 and the antenna system 52.

When the RF card 90 is detected above and to the right of the antenna system 52 (as shown in FIG. 5a) then the LEDs 76 that are visible to the customer (that is, the LEDs 76 that are not obscured by the RF card 90) are illuminated in red to indicate to the customer that the RF card 90 needs to be moved substantially. The customer can then move the RF card 90 to cover some of the red LEDs 76. Thus, when the LEDs are illuminated red it indicates that the RF card 90 is poorly aligned so that satisfactory communication may not be possible.

If the RF card 90 is then detected above the antenna system 52 (as shown in FIG. 5b) then the LEDs 76 that are visible to the customer are illuminated in yellow to indicate to the customer that the RF card 90 needs to be moved by a small amount to cover the yellow LEDs 76. Thus, when the LEDs are illuminated yellow it indicates that the RF card 90 alignment is borderline, so that satisfactory communication may not be maintained for the entire transaction.

If the RF card 90 is detected directly in front of the antenna system 52 (as shown in FIG. 5c) then the LEDs 76 that are visible to the customer are illuminated in green to indicate to the customer that the RF card 90 is properly aligned. Thus, when the LEDs are illuminated green it indicates that the RF card 90 alignment is good, so that satisfactory communication should be possible for the entire transaction.

This visual feedback is provided to the ATM customer throughout the transaction.

When the proximity reader 12a is communicating with the RF card 90, the DSP 74 pulses the LEDs 76 repeatedly (for example, illuminated green then off) to indicate to the customer that the RF card 90 is being read from or written to.

In this embodiment, the LED array 76 may be viewed as three concentric diamond shapes. When the proximity reader 12a is communicating with the RF card 90, the DSP 74 may repeatedly pulse the three diamond shapes starting at the outer diamond shape, then the middle diamond shape, then the inner diamond shape. This will inform the ATM customer that communication between the RF card 90 and the proximity reader 12a is taking place.

If the RF card 90 is being held too far away from the proximity reader 12a, then the LED array 76 may illuminate only the central diamond in green, thereby indicating to the ATM customer that the RF card 90 should be brought closer to the antenna system 52 but without changing the alignment of the RF card 90 relative to the antenna system 52.

Optional Feedback via ATM Display

Optionally, in addition to the visual guidance provided by the LEDs 76, the ATM controller 12i may provide visual guidance on the display 12c, or on part of the display 12c (for example, on the lower right hand corner). This can occur if the DSP 74 provides positional information about the RF card 90 to the ATM controller 12i via the data bus 80.

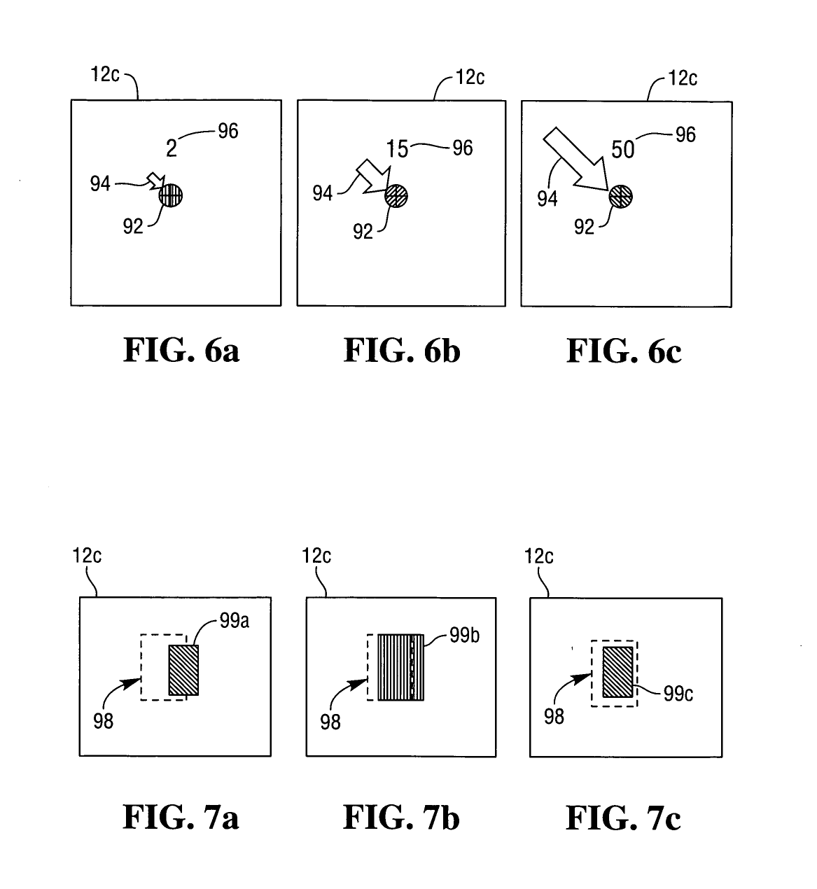

FIGS. 6a to 6c illustrate one possible implementation of this visual feedback via the display 12c. In this example, a circle 92 represents the RF card 90, a directional arrow 94 indicates the direction in which the RF card 90 should be moved to achieve perfect alignment, and a distance value 96 indicates how much the RF card should be moved by. The distance value 96 may correspond to a standard measurement, for example, millimeters.

In FIG. 6a, the RF card 90 is correctly aligned because the central circle 92 is green, the directional arrow 94 is small, and the distance value 96 is low (“2”).

In FIG. 6b, the RF card 90 is not correctly aligned, but communication may still be possible, because the central circle 92 is yellow, the directional arrow 94 is medium sized, and the distance value 96 is medium (“15”). The ATM customer should move the RF card 90 a small amount in the direction of the directional arrow 94 to achieve perfect alignment.

In FIG. 6c, the RF card 90 is poorly aligned, so communication may not be possible. This is indicated by a red central circle 92, a large directional arrow 94, and a high distance value 96 (“50”). The ATM customer must move the RF card 90 a relatively large amount in the direction of the directional arrow 94 to achieve satisfactory alignment.

FIGS. 7a to 7c illustrate another possible implementation of this visual feedback via the display 12c. In this example, a reference image 98 (shown as a broken line) represents the ideal position for the RF card 90; a guidance image of the RF card 99 is also shown relative to the ideal position.

If the guidance image 99 is shown smaller than the reference image 98 then the RF card 90 is being held too far away from the antenna system 52; if the guidance image 99 is shown larger than the reference image 98 then the RF card 90 is being held too close to the antenna system 52 (which may not be possible); and if the guidance image 99 is shown the same size as the reference image 98 then the RF card 90 is being held at the correct distance from the antenna system 52. Similarly, if the guidance image 99 is shown to the right of the reference image (as shown in FIG. 7a) then the RF card 90 should be moved to the left.

In addition, the guidance image 99 may be colored to indicate how close to perfect alignment the RF card 90 is being held. Red indicates that significant movement is required, yellow that some movement is required, and green that no movement is necessary.

In FIG. 7a, the guidance image 99a is smaller than, and to the right of, the reference image 98, and is colored red. This indicates to the ATM customer that the RF card 90 should be moved substantially to the left and closer to the antenna system 52 for satisfactory communication with the proximity reader 12a.

In FIG. 7b, the guidance image 99b is the same size as, but slightly to the right of, the reference image 98, and is colored green. This indicates that the RF card 90 should be moved slightly to the left for perfect communication with the proximity reader 12a, but can be held in the current position for satisfactory communication with the proximity reader 12a.

In FIG. 7c, the guidance image 99c is smaller than, but aligned with, the reference image 98, and is colored red. This indicates that the RF card 90 should be moved substantially closer to the antenna system 52 for satisfactory communication with the proximity reader 12a.

Once the RF card 90 has been aligned satisfactorily and the proximity reader 12a is communicating with the RF card 90, the ATM controller 12i may cause the guidance image 99 to pulse, indicating that communication is taking place, or some other visual cue may be provided to indicate to the ATM customer that the proximity reader 12a is communicating with the RF card 90.

RF Card Communication

The visual feedback process described in relation to step 118 continues throughout the transaction.

When the RF card 90 is sufficiently well aligned for reliable communication, indicated by similar signal strength from each antenna segment 56 on the control channel 78, the DSP 74 attempts to communicate with the RF card 90 (step 120).

If a timeout occurs (step 122) before the proximity reader 12a is able to communicate with the proximity reader 12a (at this stage, by reading the information stored in the RF card 90) (step 124), then the proximity reader flow 100 loops back to the initial step of detecting an RF card (step 110), and notifies the ATM controller flow 150 that the RF card could not be successfully communicated with (not shown in FIG. 4). The ATM controller flow 150 may present an error screen to the ATM customer explaining that their RF card 90 could not be read or written to (whichever is appropriate). The timeout may be selected to be relatively short, for example, thirty seconds.

If a timeout does not occur, but communication has not been successful, then the proximity reader flow reverts to step 116 and attempts to communicate with the RF card 90 again.

If the proximity reader 12a can communicate with the RF card 90 (at this stage, by reading the information stored in the RF card 90) before the predetermined time period (the timeout) has expired, then the proximity reader 12a notifies the ATM controller 12i accordingly (step 126). At this stage of the transaction, this involves the proximity card reader 12a notifying the ATM controller 12i of the RF card details read in response to a request therefrom (as will be described below). At a subsequent stage of the transaction (the communication phase is invoked for both reading data from and writing data to the RF card 90), notifying the ATM controller 12i involves sending a ‘write confirmation message’ to the ATM controller 12i (as illustrated by broken line 128).

Returning now to the ATM controller flow 150 in the flow diagram shown in FIG. 4, when the ATM controller 12i receives notification from the proximity reader 12a that an RF card 90 has been detected (see step 112), then the controller flow 150 moves to step 154.

Option for Conventional or RF Card

On receipt of this notification that an RF card has been detected, the ATM controller 12i presents a confirmation screen on the display 12c (step 154), which requests that the ATM customer confirms (via the appropriate selection of an FDK 12d or a key on the encrypting keypad 12e) that they would like the transaction to proceed based on the detected RF card (step 156).

Conventional ATM Card Transaction

If the ATM customer does not want to use the proximity reader 12a (for example, because the RF card is located within a purse or wallet that is resting on the ATM 10 but the ATM customer prefers to use a conventional magnetic stripe card), then the ATM customer selects an option to use a conventional card.

In response to this selection, the ATM controller 12i presents a card insertion screen (step 158) inviting the ATM customer to insert a conventional ATM card into the legacy card reader 12h. The ATM controller 12i may also inform the proximity reader 12a that it will not be used for this transaction (not illustrated in FIG. 4).

If a conventional ATM card is received within a preset time period (for example, sixty seconds) (step 160) then the ATM controller 12i proceeds with a conventional transaction based on the received conventional ATM card (step 162) until the transaction is completed (step 164).

If a conventional ATM card is not received within the preset time period (sixty seconds in this example) (step 160) then the controller 12i returns to the attract screen at step 152.

RF Card Transaction

If the customer does want to use the proximity reader 12a at step 156, then the ATM controller 12i proceeds with a transaction by requesting RF card details from the proximity reader 12a. As described above, provided the proximity reader 12a could read the RF card 90, the proximity reader 12a will provide the read RF card details at step 126. These details are received by the ATM controller flow 150 (step 166).

These read RF card details are then used by the ATM controller 12i to present transaction options to the ATM customer. Once the ATM customer has selected a transaction, and the ATM 10 has fulfilled the transaction, any transaction details that need to be written to the RF card 90 (for example, where the RF card 90 is a stored value card, the amount of money debited from the RF card 90) are provided to the proximity reader 12a (step 168).

Writing Details to RF Card

When the proximity reader 12a receives the details to be written to the RF card 90, the proximity reader 12a immediately enters the communication phase (steps 116 to 124), which was described with respect to reading details from the RF card 90.

Provided the proximity reader 12a is able to write these transaction details to the RF card 90, the proximity reader 12a notifies the ATM controller 12i that the transaction details were successfully written (see line 128).

If, prior to a predetermined time period expiring (for example, twenty seconds) (step 170), the ATM controller 12i receives this write notification (step 172), then the transaction is completed and the session is closed (step 174).

If the ATM controller 12i does not receive the write notification prior to the predetermined time period, then the ATM controller flow 150 reverts to the attract screen (step 152) and records in a log that the transaction could not be confirmed. Optionally, prior to displaying the attract screen the ATM controller 12i may display an error screen explaining to the ATM customer that the RF card 90 could not be written to. This error screen may allow the ATM customer to request another opportunity to present the RF card 90 so that the transaction can be successfully completed.

It will now be appreciated that the above embodiment reduces the possibility of data loss, and improves transaction speed and efficiency by providing feedback to a customer about how well their card is positioned for communicating with the proximity reader. The above embodiment also reduces customer frustration that occurs when transactions cannot be completed because of a communication failure resulting from misalignment between the card and the proximity reader. The improved usability resulting from this embodiment should assist the widespread adoption of contactless (proximity) tokens.

Various modifications may be made to the above described embodiment within the scope of the invention, for example, in other embodiments the antenna system 52 may comprise a single antenna with no segments. In such embodiments, conventional calculations may be used to ascertain the distance of the RF card from the single antenna.

In other embodiments, a different token may be used than an RF card. For example, the token may be a circuit incorporated into a cellular telephone, a personal digital assistant (PDA), a digital wallet, a ring, an article of clothing, or the like.

In other embodiments that use the display 12c to provide visual alignment feedback similar to that of FIGS. 6a to 6c, the whole screen may be illuminated the appropriate color (for example, green for perfect alignment).

In other embodiments audible feedback may be provided in addition to visual feedback.

In other embodiments, the display 12c may only be used to provide visual alignment feedback if the RF card 90 is poorly aligned. The ATM controller 12i may replace the current transaction screen with a screen illustrating how the RF card 90 should be moved (for example, in a similar manner to the examples of FIGS. 6c and 7c); once the RF card 90 is correctly aligned, the ATM controller 12i may re-display the transaction screen that was replaced.

The specific values of the predetermined time periods provided above, and other specific values, are merely given by way of example.

In other embodiments, on completion of the reading and writing the proximity reader 12a and/or the ATM controller 12i may provide additional feedback to the ATM customer so that the ATM customer knows that it is safe to remove the RF card 90. If there is a fault during the processing then this may be displayed to the ATM customer by changing the colors of the pulsing LEDs, and/or by presenting an error screen on the display 12c, so that the ATM customer is informed that there has been a fault and that the process may have to restart or may take longer than expected.

In other embodiments, the visual feedback may be provided by the proximity reader only, by the display only, or by both the proximity reader and the display.

In other embodiments a self-service terminal other than an ATM may be provided, for example, a check-out terminal or one of the terminals listed in the background section.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

What is claimed is:

1. A method of improving communications between a proximity token and a proximity token reader, the method comprising:
(a) detecting a position of the proximity token relative to the proximity token reader;
(b) providing feedback to a user about the detected position of the proximity token relative to a desired position for satisfactory communication between the proximity token and the proximity token reader;
(c) repeating steps (a) and (b) until communication between the proximity token and the proximity token reader has been completed or a preset time interval has elapsed.

2. A method according to claim 1, wherein the method comprises the further step of:
(a-1) detecting an amount of background noise and compensating for this detected background noise during step (a).

3. A method according to claim 1, wherein step (a) includes detecting a distance of the proximity token from the proximity token reader in a first direction and detecting a distance of the proximity token from the proximity token reader in a second direction orthogonal to the first direction.

4. A method according to claim 1, wherein step (a) includes calculating the position of the proximity token based on signal strength, the power of the token reader, the gain of an antenna on the token reader and the gain of an antenna on the proximity token.

5. A method according to claim 1, wherein step (b) comprises providing visual feedback to the user via a display.

6. A method according to claim 1, wherein step (b) comprises providing visual feedback to the user via visual elements on the proximity token reader.

7. A method according to claim 1, wherein step (b) comprises providing audible feedback to the user via a loudspeaker.

8. A method according to claim 1, wherein the method comprises the further step of:
(c-1) indicating to the user when the token reader is communicating with the proximity token.

9. A method according to claim 1, wherein the method comprises the further step of:
(d) aborting communication with the proximity token and indicating that a communication failure has occurred when the preset time interval has elapsed.

10. A proximity token reader comprising:
a processor;
an antenna coupled to the processor for communicating with a proximity token; and
a visual indicator;
the processor being operable (i) to detect a position of a proximity token relative to the antenna; and (ii) to provide feedback to a user via the visual indicator about the detected position of the proximity token relative to a desired position for satisfactory communication between the proximity token and the antenna.

11. A proximity token reader according to claim 10, wherein the visual display comprises one or more light emitting diodes.

12. A self-service terminal comprising:
a proximity token reader including a processor associated with the proximity token reader;
a terminal processor associated with the self-service terminal, and in communication with the proximity token reader; and
a display controlled by the terminal processor;
the reader processor being operable (i) to detect a position of a proximity token relative to the proximity token reader; and (ii) to provide feedback to a user about the detected position of the proximity token relative to a desired position for satisfactory communication between the proximity token and the proximity token reader.
